(19) United States
(12) Patent Application Publication
(10) Pub. No.: US 2024/0104137 A1
(43) Pub. Date: Mar. 28, 2024

(54) MAIN PATH ANALYSIS METHOD AND DEVICE

(71) Applicant: Institute of Medical Information, Chinese Academy of Medical Sciences, Beijing (CN)

(72) Inventors: Ting ZHANG, Beijing (CN); Zhaolian OUYANG, Beijing (CN)

(21) Appl. No.: 18/529,648

(22) Filed: Dec. 5, 2023

(30) Foreign Application Priority Data
Jul. 12, 2023 (CN) 202310851036.X

(51) Int. Cl. G06F 16/901

(52) U.S. Cl. CPC G06F 16/9024

(57) ABSTRACT

A main path analysis method is performed as follows. Distribution information of a source node, a sink node, and a process node in a citation network is acquired. When the distribution information satisfies a preset distribution condition, an edge connected to a specific node in the citation network is masked to obtain a sub-network, where the specific node includes the source node and/or the sink node. A citation relationship of the specific node is saved, and a main path of the sub-network is acquired. Based on the citation relationship of the specific node, a citation relationship associated with the main path of the sub-network is supplemented to the main path of the sub-network, so as to obtain the main path of the citation network. A main path analysis device is further provided.

### CROSS-REFERENCE TO RELATED APPLICATIONS

This application claims the benefit of priority from Chinese Patent Application No. 202310851036.X, filed on Jul. 12, 2023. The content of the aforementioned application, including any intervening amendments thereto, is incorporated herein by reference in its entirety.

### TECHNICAL FIELD

This application relates to data processing, and more particularly to a main path analysis method and device.

### BACKGROUND

A citation network is a Directed Acyclic Graph (DAG) consisting of citing and cited relationships among literature materials. The literature materials include technical journals, patent documents, conference proceedings, scientific and technical reports, and academic dissertations. Among them, each literature material acts as a node in the citation network, and the nodes are connected through the citing and cited relationship between the literature materials, in order to form the edge between two nodes in the citation network.

After constructing the citation network, the main path analysis method is utilized to extract the main path used to reflect the main vein of technological development (namely, the direction of technological development) from the citation network. The main path analysis method mainly calculates the weight of each edge in the citation network and extracts the main path from the citation network based on the weight of each edge. However, the main path analysis method is time-consuming.

### SUMMARY

Objects of this application are to provide a main path analysis method and device, for ensuring the integrity of the main path while improving the time-consuming problem.

Technical solutions of this application are described as follows.

In a first aspect, this application provides a main path analysis method, comprising:
acquiring distribution information of a source node, a sink node, and a process node in a citation network;
when the distribution information satisfies a preset distribution condition, masking an edge connected to a specific node in the citation network to obtain a sub-network of the citation network, wherein the specific node comprises the source node and/or the sink node;
saving a citation relationship of the specific node, wherein the edge connected to the specific node is obtained by using the citation relationship of the specific node; and
acquiring a main path of the sub-network as a first main path; and supplementing a citation relationship associated with the first main path to the first main path based on the citation relationship of the specific node, so as to obtain a main path of the citation network;
wherein the step of “masking an edge connected to a specific node in the citation network when the distribution information satisfies the preset distribution condition, and saving the citation relationship of the specific node” comprises:
if a proportion of the source node in the citation network is greater than a proportion of the process node in the citation network, masking an edge connected to the source node, and saving a citation relationship of the source node; and/or
if a proportion of the sink node in the citation network is greater than a proportion of the process node in the citation network, masking an edge connected to the sink node, and saving a citation relationship of the sink node.

In an embodiment, the main path analysis method further comprises:
constructing a first main path network based on nodes and edges in the main path of the citation network;
acquiring a main path of the first main path network as a second main path; and
updating the main path of the citation network to the second main path if the second main path does not match the main path of the citation network.

In an embodiment, the step of “updating the main path of the citation network to the second main path if the second main path does not match the main path of the citation network” comprises:
if the second main path does not match the main path of the citation network, constructing a second main path network based on nodes and edges in the second main path, and obtaining a main path of the second main path network as a third main path;
if the third main path matches the second main path, updating the main path of the citation network to the second main path; and
if the third main path does not match the second main path, updating the second main path to the third main path; based on nodes and edges in the third main path, constructing a third main path network, and obtaining a main path of the third main path network as a fourth main path; and if the fourth main path matches the third main path, updating the main path of the citation network to the third main path.

In an embodiment, the step of “constructing the first main path network based on nodes and edges in the main path of the citation network” comprises:
constructing the first main path network based on the nodes and the edges in the main path of the citation network after receiving that a user triggers a main pain extraction operation again; or
if path parameters of the main path of the citation network satisfy a preset main path analysis condition, constructing the first main path network based on the nodes and edges in the main path of the citation network; wherein the path parameters comprise at least one of a proportion of the process node in the main path of the citation network, the number of nodes in the main path of the citation network, and the number of the main path of the citation network.

In an embodiment, the step of “supplementing a citation relationship associated with the first main path to the first main path based on the citation relationship of the specific node, so as to obtain a main path of the citation network” comprises:
in the case that the specific node comprises the source node, determining all source nodes referenced by a starting point of the first main path based on a citation relationship of the source node; based on an out-degree of each of the source nodes referenced by the starting point of the first main path, selecting and adding a source node to the first main path, and restoring an edge relationship between the source node added to the first main path and the starting point of the first main path; and/or
in the case that the specific node comprises the sink node, determining all sink nodes referenced by an end point of the first main path based on a citation relationship of the sink node; based on an in-degree of each of the sink nodes referenced by the end point of the first main path, selecting and adding a sink node to the first main path; and restoring an edge relationship between the sink node added to the first main path and the end point of the first main path.

In a second aspect, this application further provides a main path analysis device, comprising:
a first acquisition unit;
a masking unit;
a saving unit;
a second acquisition unit; and
a supplementing unit;
wherein the first acquisition unit is configured for acquiring distribution information of a source node, a sink node, and a process node in a citation network;
the masking unit is configured for masking an edge connected to a specific node in the citation network to obtain a sub-network of the citation network when the distribution information satisfies a preset distribution condition, wherein the specific node comprises the source node and/or the sink node;
the saving unit is configured for saving a citation relationship of the specific node, wherein the edge connected to the specific node is obtained by using the citation relationship of the specific node;
the second acquisition unit is configured for acquiring a main path of the sub-network as a first main path;
the supplementing unit is configured for supplementing a citation relationship associated with the first main path to the first main path based on the citation relationship of the specific node, so as to obtain a main path of the citation network;
wherein if a proportion of the source node in the citation network is greater than a proportion of the process node in the citation network, the masking unit is configured for masking an edge connected to the source node, and the saving unit is configured for saving a citation relationship of the source node;
and/or
if a proportion of the sink node in the citation network is greater than a proportion of the process node in the citation network, the masking unit is configured for masking an edge connected to the sink node, and the saving unit is configured for saving a citation relationship of the sink node.

In an embodiment, the main path analysis device further comprises:
a construction unit;
a third acquisition unit; and
an updating unit;
wherein the construction unit is configured for constructing a main path network based on nodes and edges in the main path of the citation network;
the third acquisition unit is configured for acquiring a main path of the main path network as a second main path; and
the updating unit is configured for updating the main path of the citation network to the second main path if the second main path does not match the main path of the citation network.

In an embodiment, in the case that the specific node comprises the source node, the supplementing unit is configured for determining all source nodes referenced by a starting point of the first main path based on a citation relationship of the source node; based on an out-degree of each of the source nodes referenced by the starting point of the first main path, selecting and adding a source node to the first main path; and restoring an edge relationship between the source node added to the first main path and the starting point of the first main path;

and/or
in the case that the specific node comprises the sink node, the supplementing unit is configured for determining all sink nodes referenced by an end point of the first main path based on a citation relationship of the sink node; based on an in-degree of each of the sink nodes referenced by the end point of the first main path, selecting and adding a sink node to the first main path; and restoring an edge relationship between the sink node added to the first main path and the end point of the first main path.

In a third aspect, this application further provides computer-readable storage medium, wherein a program is stored on the computer-readable storage medium, and the program is configured to be executed by a processor to implement the main path analysis method.

Compared to the prior art, this application has the following beneficial effects.

If the distribution information of the citation network satisfies a predetermined distribution condition, the edges connected to the specific nodes are masked to obtain a sub-network of the citation network. Such a way greatly reduces the number of nodes of the sub-network and effectively reduces the amount of computation in the process of obtaining the first main path of the sub-network. After obtaining the first main path of the sub-network, the saved citing relations of specific nodes are utilized to supplement the citing relations related to the first main path in the first main path, thereby obtaining the main path of the citation network. As a result, in the process of analyzing the main path of the citation network, it is not necessary to calculate the weights of the edges connected to the specific nodes, which reduces the amount of computation and thus reduces the time-consuming analysis of the main path. Moreover, the citing relations related to the first main path are supplemented on the first main path, so that the main path of the citation network is an information-complete path, which ensures the completeness of the main path.

### BRIEF DESCRIPTION OF THE DRAWINGS

In order to illustrate the embodiments of the present disclosure or the technical solution in the prior art more clearly, the drawings required in the description of the embodiments or the prior art will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a schematic diagram of a Directed Acyclic Graph (DAG) according to one embodiment of the present disclosure;

FIG. 2 is a schematic diagram of a Directed Cyclic Graph (DCG) according to one embodiment of the present disclosure;

FIG. 3 is a flowchart of a main path analysis method according to one embodiment of the present disclosure;

FIG. 4 is a schematic diagram of a patent citation network according to one embodiment of the present disclosure;

FIG. 5 is a schematic diagram of a sub-network of a patent citation network according to one embodiment of the present disclosure;

FIG. 6 is another flowchart of a main path analysis method according to one embodiment of the present disclosure;

FIG. 7 is a schematic diagram of a structure of a main path analysis device according to one embodiment of the present disclosure; and

FIG. 8 is a schematic diagram of another structure of the main path analysis device according to one embodiment of the present disclosure.

### DETAILED DESCRIPTION OF EMBODIMENTS

The technical solutions in the embodiments of the present disclosure will be clearly and completely described below in conjunction with the accompanying drawings of the present disclosure. It is clear that described below are merely some embodiments of the disclosure, which are not intended to limit the disclosure. For those skilled in the art, other embodiments obtained based on these embodiments without paying creative efforts should fall within the scope of the disclosure.

First, the terms involved in the embodiments of the present disclosure are described.

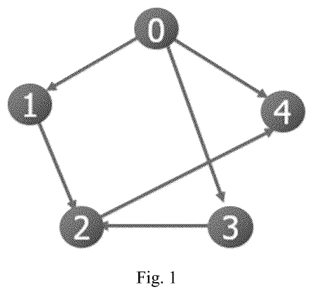

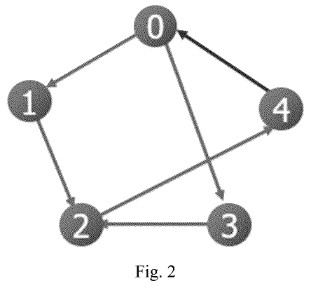

Directed Acyclic Graph (DAG): DAG consists of nodes and lines with one-way arrow between nodes, and there are no loops in the composed structure graph. FIG. 1 illustrates an example of a directed acyclic graph. In FIG. 1, each number represents one node, e.g., the number 0 can represent node 0 in the directed acyclic graph, the number 1 can represent node 1 in the directed acyclic graph, and the lines with one-way arrow between the nodes are edges between the two nodes. In addition to the directed acyclic graph, a plurality of nodes can form a Directed Cyclic Graph (DCG) by connecting lines, as shown in FIG. 2. In FIG. 2, 0-1-2-4-0 forms a loop. The citation network in this disclosure is the directed acyclic graph.

In-degree of a node: the number of arrows to which the node is pointed.

Out-degree of a node: the number of arrows that the node points out. For example, in FIG. 1, node 2 has an out-degree of 1 and an in-degree of 2.

Node type: the directed acyclic graph includes source nodes, sink nodes, process nodes, and independent nodes. Specifically, the starting point of the directed acyclic graph is the source node, and the end point of the directed acyclic graph is the sink node. When illustrated by the out-degree and the in-degree, the node with an in-degree of 0 is the source node, the node with an out-degree of 0 is the sink node, the node with both out-degree and in-degree of 0 is independent node, and the node with neither out-degree nor in-degree of 0 is process node.

Patent citation network: each patent is regarded as one node in the directed acyclic graph. One patent may have a citing patent or a cited patent or both citing patent and cited patent. The citation relationships of all patents constitute the patent citation network.

Main path: also known as the main vein referring to the path from one source node to one sink node of the citation network. Nodes on the main path are regarded as the more important content/direction in the research process, in order to form the main vein of technological development through the nodes on the main path. One citation network may include multiple main paths.

The main path of the citation network can be obtained based on the weight of each edge in the citation network. For example, all the optional paths from any source node to any sink node of the citation network are found, and the weight of each optional path is calculated based on the weight of each edge in each optional path. For example, the optional path with the largest weight is selected from all the optional paths as the main path of the citation network. However, the number of nodes in the citation network is large, and the weight calculation is time-consuming. Especially, when the source nodes and sink nodes account for a large proportion of the citation network, many weights of the optional paths from any source node to any sink node need to be calculated in extracting the main path, resulting in a huge amount of computation, which increases the consuming time for the analysis of the main path. This problem becomes more and more serious with the increase in the number of nodes in the citation network.

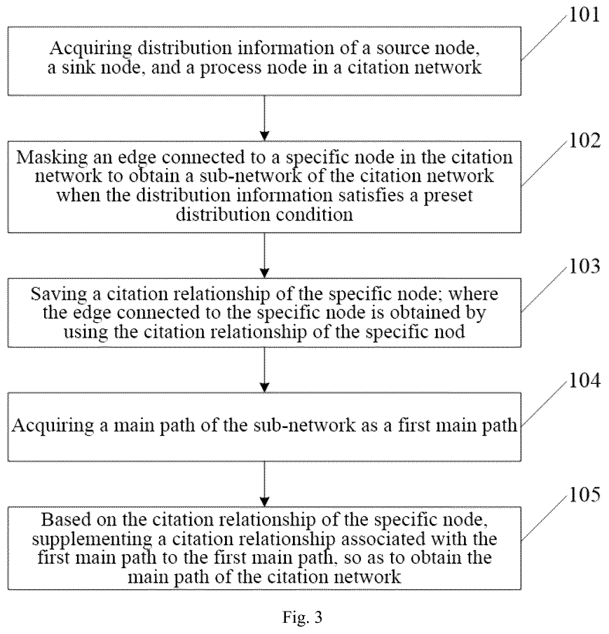

This disclosure provides a main path analysis method that reduces the amount of computation in the process of analyzing the main path of the citation network, so as to reduce the consuming time of main path analysis and ensure the integrity of the main path. FIG. 3 illustrates a flowchart of the main path analysis method, which may include the following steps.

101. Distribution information of the source node, the sink node, and the process node in the citation network is acquired. In this embodiment, the citation network may be a directed acyclic graph that is pre-constructed based on the citing and cited relationships among the literature materials. The process of constructing the citation network includes obtaining the citation relationships of the literature materials; constructing a connecting line between the literature materials based on the citation relationships of the literature materials; taking the connecting line as the edge between the literature materials; and connecting all the literature materials based on the citation relationships of the literature materials, so as to obtain the citation network of the literature materials.

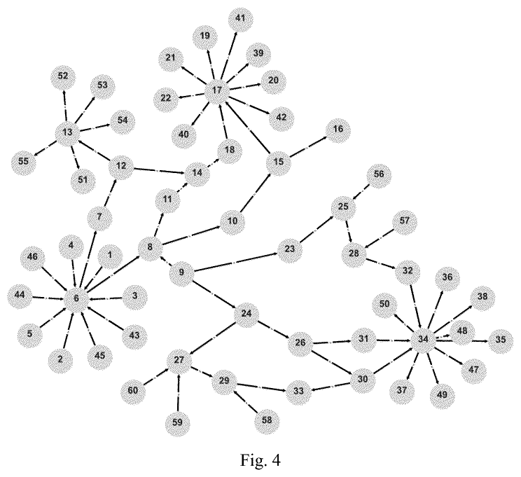

Taking the patent citation network as an example, the CP field information (i.e., cited patent information) of each patent is extracted from the downloaded patent documents in order to constitute the patent citation relationship between the patent documents. Based on the patent citation relationship, the directed acyclic graph as a patent citation network is constructed, such as the patent citation network illustrated in FIG. 4. Therein, the patent citation relationship between the patent documents indicates the citing and cited relationship between the two patent documents. The patent citation relationship between the patent documents is used to construct edges between the patent documents, and the arrow direction of the edge is determined based on the patent citation relationship. For example, if the patent document A cites the patent document B, then an edge is connected between the patent document A and the patent document B, and the arrow of the edge is pointing to the patent document A from the patent document B. The directed acyclic graph as one patent citation network is obtained after completing the connection between all the patent documents.

In this embodiment, the distribution information of the nodes is used to indicate the proportion of the nodes in the citation network. The distribution information for any type of node is the proportion of the number of this type of nodes to the total number of nodes in the citation network. Since the independent nodes do not have citation relationships with other nodes, thereby making no edge connections between independent nodes and other nodes, independent nodes are irrelevant to the main path extraction.

102. In the case that the distribution information satisfies the preset distribution conditions, the edges connected to specific nodes in the citation network are masked in order to obtain a sub-network of the citation network. The specific nodes include source nodes and/or sink nodes.

The source node indicates the starting of a subject vein of technological development, and the sink node indicates the end of a subject vein of technological development. Therefore, the number of source nodes and/or sink nodes in the citation network is large, resulting in a larger proportion of source nodes and/or sink nodes in the citation network. As shown in the patent citation network in FIG. 4, the proportion of source nodes and sink nodes in the citation network is significantly larger than the proportion of process nodes in the citation network. Then, in the analysis process of the main path, the calculation of the weights of the edges connected to the source nodes and the sink nodes will take up a larger computational amount, thereby increasing the time-consumption of the main path analysis. To solve this problem, this embodiment may shield the edges connected to the source nodes and/or the sink nodes in the citation network, and the source nodes and/or the sink nodes are temporarily turned into independent nodes in the network (the independent nodes do not affect the calculation of the main path). The edges connected to the masked nodes are edges connected by the disabled nodes so that the weights of the edges connected to these nodes are no longer computed during the main path analysis to reduce the amount of computation.

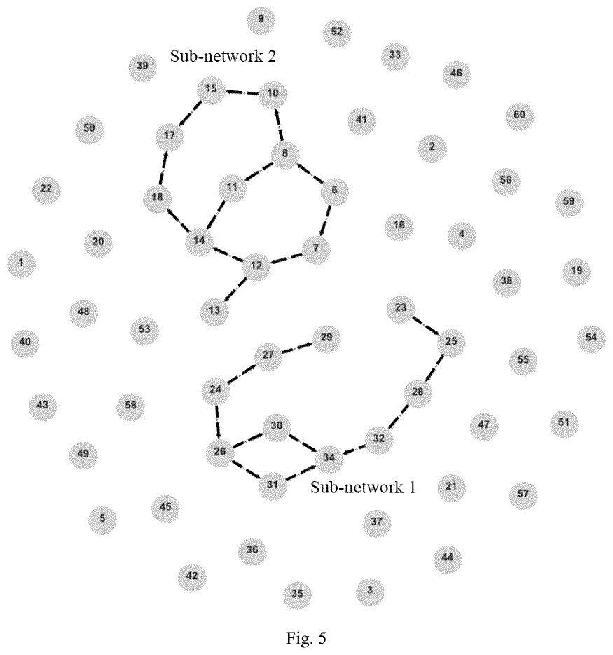

In some embodiments, the edges connected by the masked nodes may be the edges connected by the disconnected nodes. In some embodiments, the edges connected by the masked nodes may be the edges connected by the deleted nodes. By masking the edges connected by the nodes, one citation network can be divided into at least one sub-network. As in the patent citation network shown in FIG. 4, after masking the edges connected by the nodes, the patent citation network is divided into two sub-networks (sub-network 1 and sub-network 2) shown in FIG. 5.

In this embodiment, the edges connected by the nodes are masked when the distribution information of the nodes satisfies a preset condition. Specifically, the preset condition is used to indicate the edges connected to the masked nodes to increase the consuming time of main path analysis. If the distribution information of the source nodes satisfies the preset condition, the edges connected to the source nodes are masked. If the distribution information of the sink nodes satisfies the preset condition, the edges connected to the sink nodes are masked. If the distribution information of the source nodes satisfies the preset condition, and the distribution information of the sink nodes satisfies the preset condition, the edges connected by both types of nodes are masked.

In some embodiments, the preset condition may include: a proportion of the source nodes in the citation network is greater than a first predetermined proportion; and/or, a proportion of the sink nodes in the citation network is greater than a second predetermined proportion. In some embodiments, the preset condition is used to indicate a distribution comparison of the source nodes to the process nodes in the citation network, and/or, a distribution comparison of the sink nodes to the process nodes in the citation network. For example, if the proportion of the source nodes in the citation network is greater than the proportion of the process nodes in the citation network, the edges connected to the source nodes in the citation network are masked. And/or, if the proportion of the sink nodes in the citation network is greater than the proportion of the process nodes in the citation network, the edges connected to the sink nodes in the citation network are masked. In this embodiment, the preset condition may also set a gap in the proportion of the source nodes and the process nodes, and mask the edges connected by the source nodes in the citation network when the gap in the proportion is reached. And/or, the preset condition may also set a gap in the proportion of the sink nodes and the process nodes, and mask the edges connected by the sink nodes in the citation network when the gap in the proportion is reached.

It should be noted that the process nodes in one path can embody the technological development process of the main vein of technological development indicated by the path. Therefore, the importance of the process nodes is greater than that of the source nodes and the sink nodes. The process nodes in the citation network contain most of the information on the technological development, and the main path extracted therefrom can represent the main vein of technological development.

103. The citation relationship of the specific nodes is saved, and the edges connected to the specific nodes are obtained by using the citation relationship of the specific nodes. Specifically, the purpose of saving the citation relationship of the specific nodes is to recover the edges connected to the specific nodes normally. For example, after masking the edges connected to the source nodes and/or sink nodes, the source nodes and/or sink nodes of the citation network are temporarily transformed into independent nodes. The sub-network contains only the process nodes of the citation network. The main path of the sub-network can reflect the technological development process of the main vein of technological development in the citation network, but the beginning and the end of the main vein of technological development in the citation network are lost. The citation relationship of the specific nodes can supplement the beginning and the end of the main vein of technological development in the citation network, to ensure the completeness of the main vein of technological development (i.e., the main path of the citation network).

The citation relationship of the specific nodes can be stored in external files, and external files can have a one-to-one relationship with the citation network. After analyzing the main path of the citation network, the external file corresponding to the citation network is deleted, or the citation relationship of the specific nodes stored in the external file is deleted. Alternatively, an identification of the citation network (e.g., name of the citation network and/or number of the citation network) is stored in the external file. The citation relationship of the specific nodes of one citation network corresponds to the identification of that citation network, in order to differentiate the edges to which the specific node is connected by the identification of the citation network, so as to reduce the probability of incorrectly using the edges connected to the specific nodes.

In this embodiment, if the edges connected to the source nodes in the citation network are masked, the citation relationship of the source nodes is saved. If the edges connected to the sink nodes in the citation network are masked, the citation relationship of the sink nodes is saved.

104. The main path of the sub-network is acquired as a first main path. The process of obtaining the first main path includes calculating the weights of the edges of the sub-network; and obtaining the first main path from the sub-network based on the weights of the edges and the preset main path search algorithm. The weights of the edges may be calculated by at least one of the preset edge weight algorithms, such as search path count (SPC), search path link count (SPLC), search path node pair (SPNP). Then, the first main path is searched by utilizing at least one of the algorithms, such as local search, global search, and key-route search.

105. Based on the saved citation relationship of the specific nodes, the citation relationship related to the first main path is supplemented to the first main path, so as to obtain the main path of the citation network. Although the first main path is the main path of the sub-network, the first main path is composed of process nodes in the citation network, making source nodes, and/or sink nodes (depending on which edges are masked), and their edge relationships of the first main path in the citation network missing. As a result, when the main path of the citation network is obtained via the first main path, it is required to add the missing nodes to the first main path and restore the critical edge relationships, to ensure the integrity of the main path of the citation network. The critical edge relationships can be edge relationships related to nodes (e.g., starting and end points) in the first main path.

In this embodiment, according to the saved citation relationship of the specific nodes, one source node having the citation relationship with the starting point of that first main path is added to the first main path, and an edge relationship with that source node is restored; and/or, one sink node having the citation relationship with the end point of that first main path is added to the first main path, and an edge relationship with that sink node is restored. The process is as follows.

In the case that the specific node includes the source nodes, all source nodes referenced by the starting point in the first main path is determined by based on the citation relationship of the source nodes. Based on the out-degree of each of the source nodes, the added source nodes to the first main path are selected, and the edge relationship between that source node and the starting point in the first main path is restored. For example, the source node with the largest out-degree is selected, and the connecting line is added between that source node and the starting point of the first main path. A connecting arrow points from the source node to the starting point of the first main path, in order to fit the citation relationship between the source node and the starting point of the first main path, such that this source node serves as the source node of the first main path. And/or if the specific node includes the sink nodes, all sink nodes cited by the end point in the first main path is determined by using the citation relationship of the sink nodes. Based on the in-degree of each of all the sink nodes, the added sink node to the first main path is selected, and the edge relationship between the sink node and the end point in the first main path is restored. For example, the sink node with the largest in-degree is selected, a connecting line is added between that sink node and the end point of the first main path. A connecting arrow points from the end point to the sink node to conform the citation relationship between the sink node and the end point, so that that sink node serves as a sink node of the main path.

Assume that the following three first main paths are obtained from the sub-network 1 shown in FIG. 5, numbered as node numbers in the sub-network 1.

First main path 1: 23-25-28-32-34. First main path 2: 24-26-30-34. First main path 3: 24-26-31-34. Because the step of masking the connecting edges of the source nodes and the sink nodes is carried out before acquiring the first main paths, after acquiring the three first main paths in the sub-network 1, the three first main paths are added with the source nodes and the sink nodes, and restored the critical edge relationships. The critical edge relationships are the edge relationships between the starting point in the first main path and the added source node, and the edge relationships between the ending point in the first main path and the added sink node.

The source nodes associated with node 23 and node 24 and the sink nodes associated with node 34 are found from the citation relationship saved in the external file. For example, the source node associated with node 23 is [9], the source node associated with node 24 is [9], and the sink node associated with node 34 is [35, 36, 37, 38, 47, 48, 49, 50]. All the sink nodes are filtered by in-degree of the sink nodes, and the remaining sink nodes are [35, 38, 50]. The source nodes and sink nodes are added to the above three first main paths. The nine main paths of the citation network are obtained as follows: 9-23-25-28-32-34-35; 9-23-25-28-32-34-38; 9-23-25-28-32-34-50; 9-24-26-30-34-35; 9-24-26-30-34-38; 9-24-26-30-34-50; 9-24-26-31-34-35; 9-24-26-31-34-38; 9-24-26-31-34-50.

As a result, the first main path of the sub-network is obtained by analyzing the weights of the edges of the process nodes in the citation network, which can accurately extract the process nodes representing the process of technological development from the sub-network. Each node in the first main path of the sub-network serves as each process node in the main path of the citation network, which ensures the accuracy of each process node in the main path. After obtaining the first main path, according to the saved citation relationship of the source nodes and/or the sink nodes, the main path can be obtained by adding the source nodes and/or the sink nodes to the first main path and restoring the critical edge relationship, thereby eliminating the need for calculating the weights of the edges connected to the source nodes and/or the sink nodes, and reducing the amount of calculation. In the process of adding source nodes and/or sink nodes, important source nodes (e.g., source nodes that can represent the source of technological development) are selected according to the out-degree of the source nodes. Important sink nodes (e.g., sink nodes that can represent the trend of the technological development) are selected according to the in-degree of the sink nodes, which improves the accuracy of the source nodes and the sink nodes in the main path and ensures the completeness of the main path. Thus, the step of “masking the edges connected to the source nodes and/or sink nodes” can greatly reduce the computational amount of the main path analysis without affecting the accuracy of the main path extraction. The step of “adding/supplementing the source nodes and/or sink nodes as well as restoring the edge relationships” can ensure the completeness of the main path.

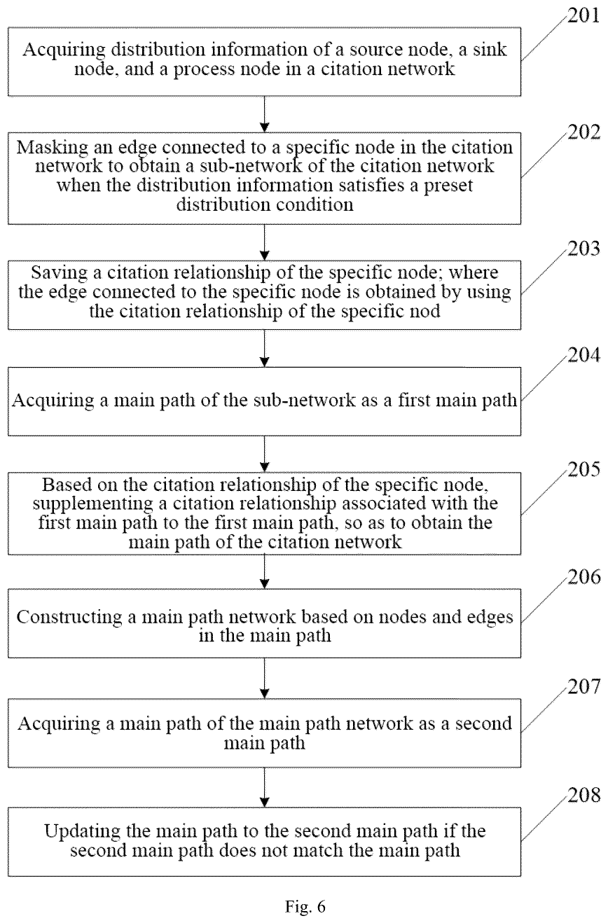

Referring to FIG. 6, another flow chart of the main path analysis method may include the following steps.

The steps 201 to 205 are the same as steps 101 to 105 above.

206. Based on the nodes and edges in the main path of the citation network, a first main path network is constructed.

It is to be understood that the nodes and edges in the main path of the citation network are the more important (i.e., with larger weights) nodes and edges in the citation network. The first main path network constructed based on these nodes and edges is a subset of the citation network. Thus, the first main path network can be regarded as a fine-grained network that can represent the citation network.

After obtaining the main path of the citation network, the edges with citation relationship are extracted from the main path of the citation network. The first main path network is constructed based on these extracted edges. Taking the nine main paths of the above citation network as an example, the edges extracted from these nine main paths include: 9-23, 9-24, 23-25, 25-28, 28-32, 32-34, 34-35, 34-38, 34-50, 24-26, 26-30, 30-34, 34-35, 34-38, 34-50, 26-31, 31-34, 34-35, 34-38, 34-50. These edges are then utilized to construct one first main path network.

Typically, the step of “adding source nodes and/or sink nodes to the first main path and restoring their edge relationships” may result in a large number of main paths of the citation network, which affects the main vein analysis of technological development of the citation network. Hence, after obtaining the main paths of the citation network, the first main path network may be constructed based on the main paths of the citation network. The main path analysis may be performed on the first main path network, thereby realizing at least secondary main path analysis for the purpose of simplification the main paths of the citation network.

In some embodiments, the step of “constructing the first main path network” may be performed once every time the main path of the citation network is acquired. The main path analysis of the citation network is ended when two adjacent main paths acquired are the same (same number and same nodes in each main path).

In some embodiments, the first main path network may be constructed after receiving that the user has triggered a main pain extraction operation again. For example, after the main paths of the citation network are obtained, the main paths of the citation network are displayed, so that the user can know the main paths of the citation network in time. If the user believes that the main paths of the citation network are more complex (e.g., the number of main paths is larger), then the user may trigger the main pain extraction operation again.

In some embodiments, in the case that the path parameters of the main path of the citation network satisfy the preset main path analysis condition, the first main path network may be constructed. In this embodiment, the path parameters include at least one of a proportion of process nodes in the main path of the citation network, the number of nodes in the main path of the citation network, and the total number of the main path of the citation network. For example, if the proportion of process nodes in the main path of the citation network is greater than a preset proportion, the first main path network is constructed. For example, if the total number of the main paths of the citation network is greater than the preset total number, the first main path network is constructed. For example, although the total number of the main paths of the citation network is less than the preset total number, the number of nodes in the main paths is greater than the preset number of nodes, or the proportion of process nodes in the main paths is greater than the preset proportion value, the first main path network is constructed. The preset proportion value, the preset total number, and the preset number of nodes are not limited, and the preset main path analysis conditions are not exhaustively described.

207. The main path of the first main path network is acquired as the second main path. The process of obtaining the second main path can be referred to in the step 104 above and will not be repeated here.

208. If the second main path does not match the main path of the citation network, the main path of the citation network is updated to the second main path. If the second main path matches the main path of the citation network, it indicates that the main path is a simplified and accurate path, the main path of the citation network is maintained unchanged. If the second main path does not match the main path of the citation network, it indicates that the main path of the citation network may not be simplified enough, and therefore the main path of the citation network needs to be updated by the operation. Because the main path of the citation network is obtained from the citation network, and the second main path is obtained from the first main path network, and the number of nodes in the first main path network is significantly smaller than the number of nodes in the citation network, the simplification degree of the second main path is greater than the simplification degree of the main path of the citation network. Whereby if the second main path does not match the main path of the citation network, the main path of the citation network can be directly updated to the second main path. Wherein, whether the main path of the citation network is simplified or not may be determined by the number of nodes of the main path of the citation network.

For example, the number of nodes of the main path of the citation network is less than a preset value, or the proportion of the number of nodes of the main path of the citation network is less than a preset proportion. Or, if two adjacent extracted main paths are the same (indicating that the main path of the citation network will not be changed again), the main path of the citation network is determined to be simplified.

In some scenarios, if there are fewer process nodes (e.g., 1 or 2) in the second main path, or if there are no process nodes in the second main path, it is difficult to analyze the main vein of technological development through this second main path, and the main path of the citation network cannot be updated to the second main path to keep the main path of the citation network unchanged.

In some scenarios, although the second main path is more simplified compared to the main path of the citation network, whether the second main path is simplified or not cannot be determined. Then, in the case that the second main path does not match the main path of the citation network, the construction of the first main path network and the acquisition of the main path of the citation network are carried out again until the main path acquired from the first main path network (that is second main path) matches the main path of the citation network, so as to find the simplified main path. The process is as follows.

If the second main path does not match the main path of the citation network, the nodes and edges in the second main path are utilized to construct a second main path network and obtain the main path of the second main path network as the third main path. If the third main path matches the second main path, the main path of the citation network will be updated to the second main path. If the third main path does not match the second main path, the second main path will be updated to the third main path. Based on the nodes and edges in the third main path, a third main path network is constructed. The main path of the third main path network is obtained as a fourth main path. If the fourth main path of the third main path network matches the third main path, and the main path of the citation network is updated to the third main path.

If the third main path matches the second main path, it indicates that the second main path is already a simplified and accurate path, the main path of the citation network may be updated to the second main path. If the third main path does not match the second main path, it indicates that the second main path may not be simplified enough; it is not possible to determine whether the third main path is a simplified main path; the second main path is then updated to the third main path; the third main path network is constructed; and the fourth main path is obtained from the third main path network until the fourth main path of the third main path network matches the third main path, and the main path of the citation network is updated to the third main path.

The above is illustrated by the following example. After obtaining the main path 1 to the main path 9 of the citation network, the main path network 1 is constructed utilizing the edges in the main path 1 to the main path 9. The second main path 1 to the second main path 8 are obtained from the main path network 1. Because the total number of main paths of the citation network is different from the total number of main paths of the main path network 1, it is determined that the main path does not match the second main path. Then, the main path network 2 is constructed utilizing the edges in the second main path 1 to the second main path 8, and the third main path 1 to the third main path 8 are obtained from the main path network 2. Although the total number of main paths of the main path network 2 is the same as the total number of main paths of the main path network 1, there is a difference in the nodes in the main paths, and it is determined that the third main path does not match the second main path. Then, the second main path is updated to the third main path 1 to the third main path 8, and the main path network 3 is constructed by using the edges in the updated second main path (i.e., the third main path 1 to the third main path 8). The third main path 9 to the third main path 17 (i.e., the third main path extracted at the second time) are obtained from the main path network 3. The third main path extracted at the second time is matched with the updated second main path, and the main path is updated to the updated second main path, i.e., the third main path 1 to the third main path 8.

In this embodiment, after obtaining the main path of the citation network, the main path network is constructed based on the nodes and edges of the main path. The second main path is obtained from the main path network. Then, according to whether the second main path matches the main path of the citation network or not, it is determined whether the main path of the citation network is updated or not, in order to complete the simplification of the main path of the citation network, so as to effectively remove redundant information in the process of extracting the main path of the citation network, so that the main path of the citation network updated based on the main path network better reflects the main vein of technological development and improves accuracy. The redundant information refers to nodes that have nothing to do with the main vein of technological development or nodes with low relevance.

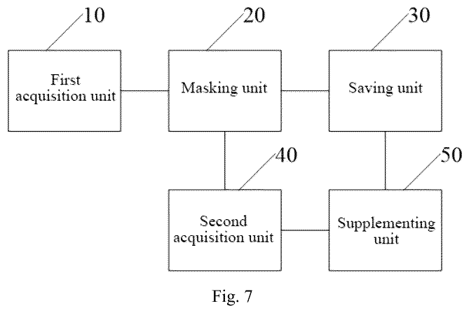

Corresponding to the above embodiments of the main path analysis method, this disclosure also provides a main path analysis device. As shown in FIG. 7, the main path analysis device includes a first acquisition unit 10, a masking unit 20, a saving unit 30, a second acquisition unit 40, and a supplementing unit 50.

The first acquisition unit 10 is configured to acquire distribution information of source nodes, sink nodes, and process nodes in the citation network. The distribution information is used to indicate the proportion of nodes in the citation network. The distribution information for any type of node is the proportion of the number of this type of nodes to the total number of nodes in the citation network. Since the independent nodes do not have citation relationships with other nodes, thereby making no edge connections between independent nodes and other nodes, independent nodes are irrelevant to the main path extraction.

The masking unit 20 is configured to mask the edges connected to specific nodes in the citation network to obtain the sub-network of the citation network if the distribution information satisfies the preset distribution condition. The specific nodes include source nodes and/or sink nodes. The edges connected to the masked nodes are edges connected by the disabled nodes so that the weights of the edges connected to these nodes are no longer computed during the main path analysis to reduce the amount of computation.

In some embodiments, if the proportion of the source nodes in the citation network is greater than the proportion of the process nodes in the citation network, the edges connected to the source nodes in the citation network are masked. And/or, if the proportion of the sink nodes in the citation network is greater than the proportion of the process nodes in the citation network, the edges connected to the sink nodes in the citation network are masked.

The saving unit 30 is configured to save the citation relationship of the specific nodes. The edge connected to the specific node is obtained by using the citation relationship of the specific node. Specifically, the purpose of saving the citation relationship of the specific nodes is to recover the edges connected to the specific nodes normally. For example, after masking the edges connected to the source nodes and/or sink nodes, the source nodes and/or sink nodes of the citation network are temporarily transformed into independent nodes. The sub-network contains only the process nodes of the citation network. The main path of the sub-network can reflect the technological development process of the main vein of technological development in the citation network, but the beginning and the end of the main vein of technological development in the citation network are lost. The citation relationship of the specific nodes can supplement the starting and the end of the main vein of technological development in the citation network, to ensure the completeness of the main vein of technological development (i.e., the main path of the citation network).

In this embodiment, if the edges connected to the source nodes in the citation network are masked, the citation relationship of the source nodes is saved. If the edges connected to the sink nodes in the citation network are masked, the citation relationship of the sink nodes is saved.

The second acquisition unit 40 is configured to acquire the main path of the sub-network as the first main path, the process of which may be described in step 104.

The supplementing unit 50 is used to supplement the citation relationship associated with the first main path in the first main path based on the saved citation relationship of specific nodes, so as to obtain the main path of the citation network. In this embodiment, an optional process of supplementing the citation relationship may be as follows. If the specific node includes the source nodes, all source nodes cited by the starting point in the first main path is determined by using the citation relationship of the source nodes. Based on the out-degree of each of all the source nodes, the added source nodes to the first main path are selected, and the edge relationship between that source node and the starting point in the first main path is restored. And/or if the specific node includes the sink nodes, all sink nodes cited by the end point in the first main path is determined by using the citation relationship of the sink nodes. Based on the in-degree of each of all the sink nodes, the added sink node to the first main path is selected, and the edge relationship between the sink node and the end point in the first main path is restored.

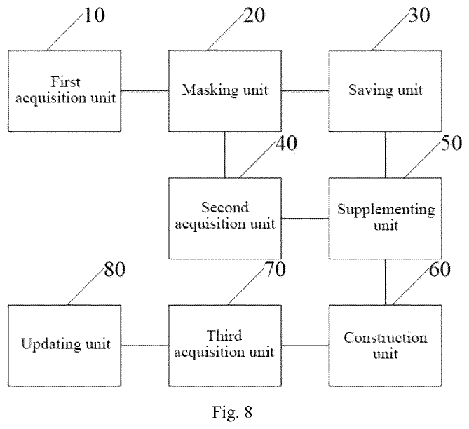

As shown in FIG. 8, in another embodiment, based on FIG. 7, the main path analysis device further includes a construction unit 60, a third acquisition unit 70, and an updating unit 80.

The construction unit 60 is configured to construct the first main path network based on nodes and edges in the main path of the citation network. For example, after obtaining the main path of the citation network, the edges with citation relationship are extracted from the main path of the citation network. The first main path network is constructed by these extracted edges.

In some embodiments, the first main path network may be constructed after receiving that the user has triggered a main pain extraction operation again. Alternatively, in the case that the path parameters of the main paths satisfy the preset main path analysis condition, the first main path network may be constructed. In this embodiment, the path parameters include at least one of the proportion of process nodes in the main path, the number of nodes in the main path, and the total number of main paths.

The third acquisition unit 70 is configured to acquire the main path of the main path network as the second main path.

The updating unit 80 is configured to update the main path of the citation network to the second main path if the second main path does not match the main path of the citation network. If the second main path matches the main path of the citation network, it indicates that the main path of the citation network is a simplified and accurate path, the main path of the citation network keeps unchanged. If the second main path does not match the main path of the citation network, it indicates that the main path of the citation network may not be simplified enough, and therefore the main path of the citation network needs to be updated.

In some embodiments, the updating unit 80 is specifically configured to construct the second main path network based on nodes and edges in the second main path and obtain the main path of the second main path network as the third main path if the second main path does not match the main path of the citation network. The updating unit 80 is further used to update the main path of the citation network to the second main path if the third main path matches the second main path. The updating unit 80 is further configured to update the second main path to the third main path if the third main path does not match the second main path; construct the third main path network based on the nodes and edges in the third main path, and obtain the main path of the third main path network as the fourth main path until the fourth main path matches the third second main path, and update the main path of the citation network to the third main path.

In this embodiment, after obtaining the main path of the citation network, the main path network is constructed based on the nodes and edges of the main path of the citation network. The second main path is obtained from the main path network. Then, according to whether the second main path of the citation network matches the main path of the citation network or not, it is determined whether the main path is updated or not, in order to simply the main path, so as to effectively remove redundant information in the process of extracting the main path of the citation network, so that the main path of the citation network updated based on the main path network better reflects the main vein of technological development and improves accuracy. The redundant information refers to nodes that have nothing to do with the main vein of technological development or nodes with low relevance.

The main path analysis device includes a processor and a memory. The above-described first acquisition unit 10, the masking unit 20, the saving unit 30, the second acquisition unit 40, and the supplementing unit 50 are stored in the memory as program units. The processor executes the above-described program units stored in the memory to realize corresponding functions.

The processor includes a kernel. The kernel is used to call the corresponding program units from the memory. The kernel may be set one or more than one. The kernel parameters are adjusted to reduce the consuming time of the main path analysis and ensure the integrity of the main path.

This disclosure provides a storage medium having the program stored thereon which implements the main path analysis method when executed by the processor.

This disclosure provides a processor which is used to run a program. The program executes the main path analysis method when run.

This disclosure provides a main path analysis device. The main path analysis device includes at least one processor, at least one memory connected to the processor, and a bus. The communication between the processor and the memory is completed via the bus. The processor is used to call program instructions in the memory to execute the main path analysis method. The main path analysis device herein may be a server, a PC, a PAD, or a cell phone.

This disclosure provides a computer program product configured to perform the main path analysis method when executed on the data processing device.

The disclosure is described in conjunction with flowcharts and/or block diagrams of methods, devices (systems), and computer program products according to embodiments of the present disclosure. Each of the processes and/or boxes in the flowchart and/or block diagram, and the combination of processes and/or boxes in the flowchart and/or block diagram, may be implemented by computer program instructions. These computer program instructions may be configured in the processor of a general-purpose computer, a special-purpose computer, an embedded processor, or other programmable data-processing devices to produce the devices such that the instructions executed by the processor of the computer or other programmable data-processing devices produce a device for carrying out the functions specified in the one process or multiple processes of the flowchart and/or one box or multiple boxes of the box diagram.

In an embodiment, the device includes one or more processors (CPUs), the memory, and the bus. The device may also include input/output interfaces and network interfaces.

The memory may include volatile memory in the computer-readable medium, random-access memory (RAM) and/or non-volatile memory, such as read-only memory (ROM) or flash memory (flash RAM). The memory includes at least one memory chip. The memory is an example of a computer readable medium.

Computer-readable medium includes volatile and non-volatile, removable and non-removable media, which may be implemented by any method or technique for information storage. The information may be computer-readable instructions, data structures, or program modules. In some embodiments, the storage media for computers includes, but are not limited to, phase-change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, compact disc read-only memory (CD-ROM), Digital Versatile Disc (DVD) or other optical storage, magnetic cartridge tape, magnetic tape disk storage or other magnetic storage device or other non-transfer medium that can be used to store information that can be accessed by the computing device. In this disclosure, the computer-readable media does not include transitory computer-readable media, such as modulated data signals and carriers.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the present claims.

What is claimed is:

1. A main path analysis method, comprising:
acquiring distribution information of a source node, a sink node, and a process node in a citation network;
when the distribution information satisfies a preset distribution condition, masking an edge connected to a specific node in the citation network to obtain a sub-network of the citation network, wherein the specific node comprises the source node and/or the sink node;
saving a citation relationship of the specific node, wherein the edge connected to the specific node is obtained by using the citation relationship of the specific node; and
acquiring a main path of the sub-network as a first main path; and supplementing a citation relationship associated with the first main path to the first main path based on the citation relationship of the specific node, so as to obtain a main path of the citation network;
wherein the step of “masking an edge connected to a specific node in the citation network when the distribution information satisfies the preset distribution condition, and saving the citation relationship of the specific node” comprises:
if a proportion of the source node in the citation network is greater than a proportion of the process node in the citation network, masking an edge connected to the source node, and saving a citation relationship of the source node; and/or
if a proportion of the sink node in the citation network is greater than a proportion of the process node in the citation network, masking an edge connected to the sink node, and saving a citation relationship of the sink node.

2. The main path analysis method of claim 1, further comprising:
constructing a first main path network based on nodes and edges in the main path of the citation network;
acquiring a main path of the first main path network as a second main path; and
updating the main path of the citation network to the second main path if the second main path does not match the main path of the citation network.

3. The main path analysis method of claim 2, wherein the step of “updating the main path of the citation network to the second main path if the second main path does not match the main path of the citation network” comprises:
if the second main path does not match the main path of the citation network, constructing a second main path network based on nodes and edges in the second main path, and obtaining a main path of the second main path network as a third main path;
if the third main path matches the second main path, updating the main path of the citation network to the second main path; and
if the third main path does not match the second main path, updating the second main path to the third main path; based on nodes and edges in the third main path, constructing a third main path network, and obtaining a main path of the third main path network as a fourth main path; and if the fourth main path matches the third main path, updating the main path of the citation network to the third main path.

4. The main path analysis method of claim 2, wherein the step of “constructing the first main path network based on nodes and edges in the main path of the citation network” comprises:
constructing the first main path network based on the nodes and the edges in the main path of the citation network after receiving that a user triggers a main pain extraction operation again; or
if path parameters of the main path of the citation network satisfy a preset main path analysis condition, constructing the first main path network based on the nodes and edges in the main path of the citation network; wherein the path parameters comprise at least one of a proportion of the process node in the main path of the citation network, the number of nodes in the main path of the citation network, and the number of the main path of the citation network.

5. The main path analysis method of claim 1, wherein the step of “supplementing a citation relationship associated with the first main path to the first main path based on the citation relationship of the specific node, so as to obtain a main path of the citation network” comprises:
in the case that the specific node comprises the source node, determining all source nodes referenced by a starting point of the first main path based on a citation relationship of the source node; based on an out-degree of each of the source nodes referenced by the starting point of the first main path, selecting and adding a source node to the first main path, and restoring an edge relationship between the source node added to the first main path and the starting point of the first main path; and/or
in the case that the specific node comprises the sink node, determining all sink nodes referenced by an end point of the first main path based on a citation relationship of the sink node; based on an in-degree of each of the sink nodes referenced by the end point of the first main path, selecting and adding a sink node to the first main path; and restoring an edge relationship between the sink node added to the first main path and the end point of the first main path.

6. A main path analysis device, comprising:
a first acquisition unit;
a masking unit;
a saving unit;
a second acquisition unit; and
a supplementing unit;
wherein the first acquisition unit is configured for acquiring distribution information of a source node, a sink node, and a process node in a citation network;
the masking unit is configured for masking an edge connected to a specific node in the citation network to obtain a sub-network of the citation network when the distribution information satisfies a preset distribution condition, wherein the specific node comprises the source node and/or the sink node;
the saving unit is configured for saving a citation relationship of the specific node, wherein the edge connected to the specific node is obtained by using the citation relationship of the specific node;
the second acquisition unit is configured for acquiring a main path of the sub-network as a first main path;
the supplementing unit is configured for supplementing a citation relationship associated with the first main path to the first main path based on the citation relationship of the specific node, so as to obtain a main path of the citation network;
wherein if a proportion of the source node in the citation network is greater than a proportion of the process node in the citation network, the masking unit is configured for masking an edge connected to the source node, and the saving unit is configured for saving a citation relationship of the source node;
and/or
if a proportion of the sink node in the citation network is greater than a proportion of the process node in the citation network, the masking unit is configured for masking an edge connected to the sink node, and the saving unit is configured for saving a citation relationship of the sink node.

7. The main path analysis device of claim 6, further comprising:
a construction unit;
a third acquisition unit; and
an updating unit;
wherein the construction unit is configured for constructing a main path network based on nodes and edges in the main path of the citation network;
the third acquisition unit is configured for acquiring a main path of the main path network as a second main path; and
the updating unit is configured for updating the main path of the citation network to the second main path if the second main path does not match the main path of the citation network.

8. The main path analysis device of claim 6, wherein in the case that the specific node comprises the source node, the supplementing unit is configured for determining all source nodes referenced by a starting point of the first main path based on a citation relationship of the source node; based on an out-degree of each of the source nodes referenced by the starting point of the first main path, selecting and adding a source node to the first main path; and restoring an edge relationship between the source node added to the first main path and the starting point of the first main path;
and/or
in the case that the specific node comprises the sink node, the supplementing unit is configured for determining all sink nodes referenced by an end point of the first main path based on a citation relationship of the sink node; based on an in-degree of each of the sink nodes referenced by the end point of the first main path, selecting and adding a sink node to the first main path; and restoring an edge relationship between the sink node added to the first main path and the end point of the first main path.

9. A computer-readable storage medium, wherein a program is stored on the computer-readable storage medium, and the program is configured to be executed by a processor to implement the main path analysis method of claim 1.
